(19) United States
(12) Patent Application Publication
(10) Pub. No.: US 2020/0189176 A1
(43) Pub. Date: Jun. 18, 2020

(54) PREFORM OF SCREEN PROTECTOR ADHESIVE FOR BUBBLE FREE APPLICATION OF SCREEN PROTECTORS

(71) Applicant: CORNING INCORPORATED, Corning, NY (US)

(72) Inventors: Sean Michael Buono, Horseheads, NY (US); John Falligent, Mount Horeb, WI (US)

(21) Appl. No.: 16/706,927

(22) Filed: Dec. 9, 2019

Related U.S. Application Data
(60) Provisional application No. 62/779,212, filed on Dec. 13, 2018.

(51) Int. Cl. B29C 63/00

(52) U.S. Cl. CPC B29C 63/0047; B29L 2031/34; B29C 63/0091

(57) ABSTRACT

Systems and methods of applying a screen protector to a surface, including aligning a first mating surface with a second mating surface within a chamber, creating a vacuum within the chamber, inflating an airbag arranged within the chamber, contacting the first mating surface with the airbag, inflating the airbag to extend towards the perimeter of the first mating surface and second mating surface, and removing all air trapped between the first mating surface and the second mating surface.

This application claims the benefit of priority under 35 U.S.C. § 119 of U.S. Provisional Application Ser. No. 62/779,212 filed on Dec. 13, 2018, the content of which is relied upon and incorporated herein by reference in its entirety.

### BACKGROUND

### Field

The present specification generally relates to screen protector application systems and methods and, more specifically, to screen protector application systems and methods that create a bubble free surface between a screen protector and cover glass of an electronic device.

### Technical Background

Screen protectors can be used on various electronic devices in order to protect a glass screen from cracking or chipping. However, the application of a screen protector can be tedious and often leads to bubbles forming between the screen protector and cover glass. Bubble formation is also a major concern for 3D shaped screens, such as those with a curved or beveled surface. Further, stronger adhesives are being explored in order to maintain a flush contact surface between the cover glass and screen protector following the initial application. But, increasingly complex cover glass and screen protector geometries in combination with stronger adhesives would make bubble removal by hand extremely difficult.

If someone attempts to apply a screen protector by hand, quite often the screen protector must be lifted one or more additional times in order to refine the alignment or eliminate trapped air bubbles. Multiple lifts of the screen protector after the initial application increases the application failure rate by providing additional opportunities for foreign material (airborne particles or fibers) to enter the space between mating surfaces, where they become trapped and create a visible defect.

Accordingly, a need exists for a system and method for applying a screen protector to the cover glass of an electronic device while minimizing bubble formation between the surfaces.

### SUMMARY

According to a first aspect, a method of applying a screen protector to a surface, including aligning a first mating surface with a second mating surface within a chamber, creating a vacuum within the chamber, inflating an airbag arranged within the chamber, contacting the first mating surface with the airbag, inflating the airbag to extend towards the perimeter of the first mating surface and second mating surface, and removing all air trapped between the first mating surface and the second mating surface.

According to any of the previous aspects, the first mating surface may further include an adhesive layer arranged between the first mating surface and second mating surface.

According to any of the previous aspects, the method may further include forcibly mating the first mating surface to the second mating surface.

According to any of the previous aspects, the fluid trapped between the first mating surface and the second mating surface is air.

According to any of the previous aspects, the airbag may initially contact the center of the first mating surface.

According to any of the previous aspects, the first mating surface and the second mating surface are glass.

According to any of the previous aspects, the adhesive layer may be applied to the second mating surface prior to the first mating surface.

According to any of the previous aspects, the airbag may be inflated via a pump.

According to any of the previous aspects the airbag may be inflated via atmospheric pressure.

According to any of the previous aspects, the airbag may be arranged above the first mating surface and second mating surface.

According to any of the previous aspects, the first mating surface and second mating surface may be held in place by an alignment fixture when contacted by the airbag.

According to a second aspect, a screen protector application system, including a chamber that can hold a vacuum, an extendable member arranged on the top surface of the chamber, and a pump arranged to apply a vacuum to the chamber, wherein when a vacuum is applied to the chamber via the pump, the extendable member extends downward into the chamber and contacts a first mating surface and a second mating surface, wherein the pressure from the extendable member forces any air arranged between the first mating surface and second mating surface out through the perimeter of the first mating surface.

According to any of the previous aspects, the extendable member may be an airbag.

According to any of the previous aspects, an adhesive layer may be arranged between the first mating surface and second mating surface.

According to any of the previous aspects, the system may further include a valve fluidly coupled to the airbag.

According to any of the previous aspects, the extendable member may apply a horizontal and vertical force to the first mating surface and second mating surface.

According to any of the previous aspects, the system may further include an alignment fixture to secure the first mating surface and second mating surface during contact with the extendable member.

According to any of the previous aspects, the system may further include a control unit communicatively connected with the pump and valve, and comprising a processor, a memory, and a computer readable and executable instruction set.

According to any of the previous aspects, the extendable member may initially contact the center of the first mating surface and moves outward towards the perimeter of the first mating surface.

According to a third aspect, a method of applying a screen protector to a surface, including sealing a chamber with electronic device arranged inside having a screen protector and/or adhesive layer arranged on a glass screen of the electronic device, evacuating the upper chamber, evacuating an airbag arranged within the upper chamber, maintaining a vacuum within the upper chamber, venting the airbag to atmospheric pressure or applying positive fluid pressure, contacting a center point of the screen protector and/or adhesive layer with the airbag, inflating the airbag until the airbag expands enough to reach the perimeter of the screen protector and/or adhesive layer, applying a vertical force across a top surface of the screen protector and/or adhesive layer to forcibly mate the screen protector and/or adhesive layer to the screen, venting the upper chamber to atmospheric pressure or applying positive pressure, venting the airbag to atmospheric pressure or applying vacuum, and breaking the seal of the upper chamber to remove the electronic device.

In some embodiments, the disclosed process relates to the automated or semi-automated application of a removable glass screen protector (SP) to a mobile device display (cover glass). A trend with modern mobile devices is to offer curved (3D) cover glass. This requires SP's having 3D shapes matching the mobile device cover glass. Various electronic devices having 3D cover glass include the Samsung S8, S8 Plus, Note8, S9 and S9 Plus, and the Apple i8, i8 Plus and iXS.

In some embodiments, the disclosed process includes the joining of a mobile device or cell phone with a screen protector, comprised of glass and a composite adhesive film of matching geometry, free from removable trapped air (bubbles). Examples of non-removable trapped air or bubbles may be those caused by screen protector misalignment with respect to the mobile device cover glass, or those caused by the presence of foreign material(s) between the screen protector adhesive and the mobile device cover glass.

In some embodiments, the disclosed process, when used in conjunction with an electro-pneumatic system designed to manage air pressures above and below a flat rubber membrane (airbag) over a short time period (<10 minutes), achieves bubble-free 3D screen protector applications.

In some embodiments, the disclosed process addresses air entrapment or bubble formation when applying screen protectors, comprised of glass and one, or more, adhesives and or anti-splinter film materials, to a mobile device cover glass. In some embodiments, the disclosed process employs the below referenced equipment and process to deform the screen protector interface material in such a way as to match or imprint (preform) the mating device cover glass surface low or high frequency uniaxial or biaxial distortion into the screen protector and cover glass interface material.

In some embodiments, the preform of the screen protector and cover glass interface material is accomplished by employing an adhesive protective barrier (film) that protects the adhesive integrity while simultaneously allowing for the deformation of the underlying interface material.

In some embodiments, once the imprint of the mating device cover glass waviness (low or high frequency uniaxial or biaxial distortion) has been imprinted into the screen protector and cover glass interface material, the protective film is removed and the screen protector is then realigned to the device cover glass, using the alignment fixture, and then put back into the applicator and subjected to a second process cycle.

In some embodiments, equipment includes a base with a hinged lid. The base has a rigid cavity or volume large enough to accommodate the largest mobile device to receive a screen protector application. The base also contains the electro-pneumatic components required for operation (vacuum pump, pressure pump, pneumatic valves and electronics). The hinged lid has a rigid frame, the rigid frame includes a seal mating with the base surrounding the base rigid cavity, and an airbag capable of distending into the base rigid cavity. With the lid closed, a sealed volume is created by the base rigid cavity, seal, and lid. The seal provided is capable of sealing a vacuum or positive pressure.

In some embodiments, the disclosed process solves the problem of air bubble entrapment by matching the low and or high level uniaxial or biaxial distortion frequency that exists in of both the cover glass and the screen protector interface. Matching of the surfaces reduces or eliminates the potential formation of air pockets between the interfaces.

In some embodiments, the disclosed process is the imprinting, or matching, of mating surfaces of a screen protector to a mobile device cover glass which in turn minimizes or eliminates mismatch in surface waviness and therefore the encapsulation or entrapment of air bubbles up adherence of screen protectors to mobile device cover glass.

In some embodiments, the disclosed process uses a multi-step process to finish the application of a pre-applied and properly aligned glass screen protector to a mobile device or cellphone in a bubble free manner. Additionally, the disclosed process applies 3D edge-to-edge laminated screen protectors to mobile devices with 3D cover glass design

In some embodiments, there are three basic stages of operation: 1.) A vacuum is applied above and below the airbag during an ambient pressure evacuation. A vacuum pump evacuates volume below the airbag surrounding the SP/device combination. The vacuum pump also evacuates the volume above the airbag to maintain static balance. Any airbag contact with the SP prior to reaching a desired evacuation level may entrap air, and therefore, should be avoided. 2.) The vacuum applied below the airbag is maintained while venting or positive pressure is applied above the airbag. The vacuum pump maintains the vacuum within the volume below the airbag surrounding the SP/device combination. The volume above the airbag is vented to the atmosphere and/or a pressure pump may be used to further pressurize the volume above the airbag. Atmospheric or positive pressure above the airbag is intended to slowly distend the airbag, resulting in forcible contact between the airbag and the SP, wherein forcible contact is initiated at or about the center of the rectangular SP and progresses outwardly from point of initial contact over time until ultimately reaching the SP perimeter. Forcible contact between the airbag and SP exterior surface ensures the SP adhesive side is forcibly mated with the mobile device cover glass. 3.) Applying positive pressure to the volume below the airbag, and vent the volume above the airbag to the atmosphere. The volume where the SP/device is arranged transitions from a vacuum to positive pressure. The volume above the airbag is vented to the atmosphere.

In some embodiments, residual bubbles may exist between the cover glass and screen protector adhesive after the mating of the screen protector to the cover glass. These bubbles may are referred to as low pressure bubbles. These low-pressure bubbles, especially if small, have the ability to self-dissipate over time once the mobile device is returned to ambient pressure. This self-dissipation phenomenon can more rapidly occur when the mobile device/screen protector combination is positively pressurized.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a perspective view of a prior art electronic device and screen protector;

FIG. 2 is a perspective view of a prior art electronic device and screen protector;

FIG. 3 is a schematic view of various surfaces according to one or more embodiments shown or described herein;

FIG. 4 is a schematic view of various surfaces according to one or more embodiments shown or described herein;

FIG. 5 a perspective view of a screen protector application device according to one or more embodiments shown or described herein;

FIG. 6 is a cross-sectional view of taken along line 7-7 in FIG. 6 of a screen protector application device according to one or more embodiments shown or described herein;

FIG. 7 is a cross-sectional view of taken along line 7-7 in FIG. 6 of a screen protector application device according to one or more embodiments shown or described herein;

FIG. 8 is a cross-sectional view of taken along line 7-7 in FIG. 6 of a screen protector application device according to one or more embodiments shown or described herein;

FIG. 9 is a cross-sectional view of taken along line 7-7 in FIG. 6 of a screen protector application device according to one or more embodiments shown or described herein;

FIG. 10 is a cross-sectional view of taken along line 7-7 in FIG. 6 of a screen protector application device according to one or more embodiments shown or described herein;

FIG. 11 is a cross-sectional view of taken along line 7-7 in FIG. 6 of a screen protector application device according to one or more embodiments shown or described herein;

FIG. 12 is a cross-sectional view of taken along line 7-7 in FIG. 6 of a screen protector application device according to one or more embodiments shown or described herein;

FIG. 13 is a detailed perspective view of a process according to one or more embodiments shown or described herein;

FIG. 14 a perspective view of an electronic device after undergoing a process according to one or more embodiments shown or described herein; and

FIG. 15 a schematic view of a process according to one or more embodiments shown or described herein.

### DETAILED DESCRIPTION

Reference will now be made in detail to embodiments of patient lift systems and methods of operating the same, examples of which are illustrated in the accompanying drawings. Whenever possible, the same reference numerals will be used throughout the drawings to refer to the same or like parts.

Embodiments of the system include a method of applying a screen protector to a surface, including aligning a first mating surface with a second mating surface within a chamber, creating a vacuum within the chamber, inflating an airbag arranged within the chamber, contacting the first mating surface with the airbag, inflating the airbag to extend towards the perimeter of the first mating surface and second mating surface, and removing all air trapped between the first mating surface and the second mating surface.

Various embodiments of screen protector application systems and methods for operating the same will be described herein with specific reference to the appended drawings.

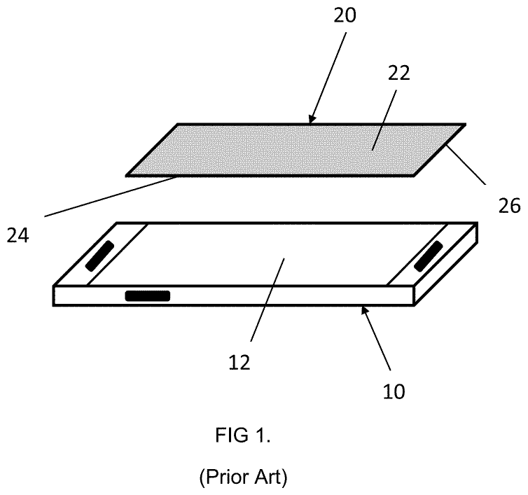

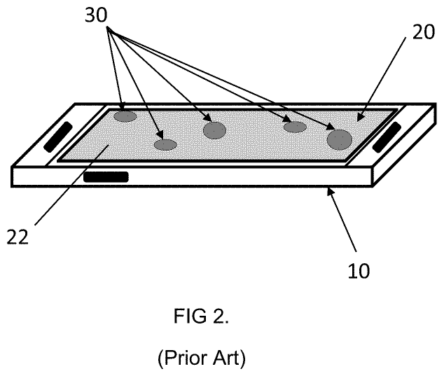

Referring now to FIG. 1 and FIG. 2, electronic device 10 is in the process of having a screen protector 20 applied to screen 12. Screen protector 20 includes top surface 22, mating surface 24, and adhesive layer 26. Adhesive layer 26 can be pre-applied to screen protector 20 or placed on screen 12 prior to screen protector 20. In some embodiments, screen 12 of electronic device 10 has 3D features, such as a curved surface or beveled edge. Due to these 3D features, apply screen protector 20 can be challenging with creating air bubbles 30 between screen 12 and screen protector 20. Even with careful application by hand, air bubbles 30 can still appear simply due to the geometry of screen 12 and screen protector 20.

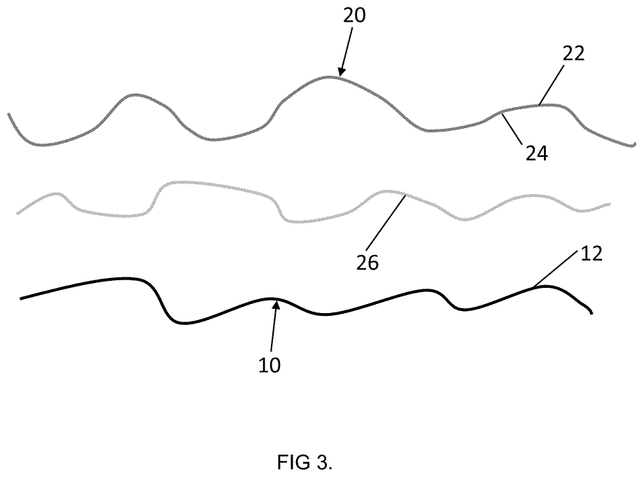

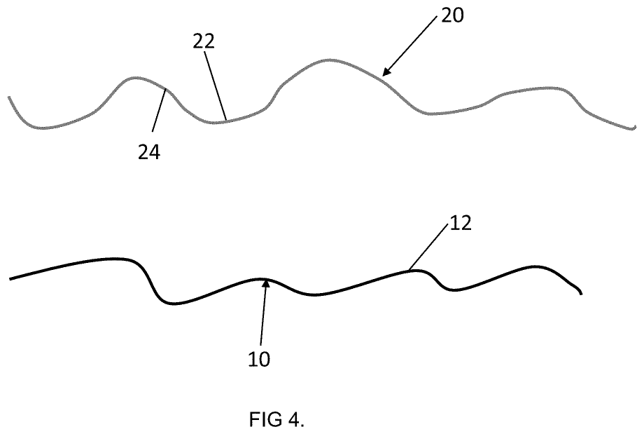

Referring now to FIG. 3 and FIG. 4, screen 12, screen protector 20, and adhesive layer 26 may all have slightly different 3D features which prevent a bubble free application. FIG. 3. and FIG. 4. show exaggerated 3D features of screen 12 and screen protector 20 to illustrate this point. Most 3D feature differences will be variations in the arc length of a curved screen or beveled edge. It can be seen from the figures that screen protector 20 was placed directly on adhesive layer 26, and then placed directly on screen 12, a plurality of air bubbles would form and be prevent from escaping due to the matting of screen 12 and screen protector 20 at various locations.

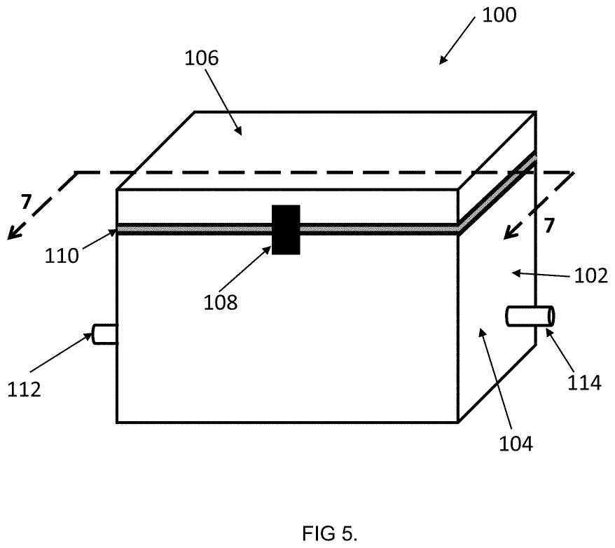

Referring now to FIG. 5, screen protector applicator 100 includes base 104 and lid 106. Seal 110 is arranged between base 104 and lid 106 to help make screen protector applicator 100 air-tight during the screen protector application process. Seal 106 can be any suitable material which seals screen protector applicator 100. Lid 106 can be hinged to base 104, and include latch 108 to further secure lid 106 to base 104. Outlet pipes 112 and 114 extend through base 104 to allow the internal compartments of screen protector applicator 100 to access atmospheric air and pressure during the screen protector application process.

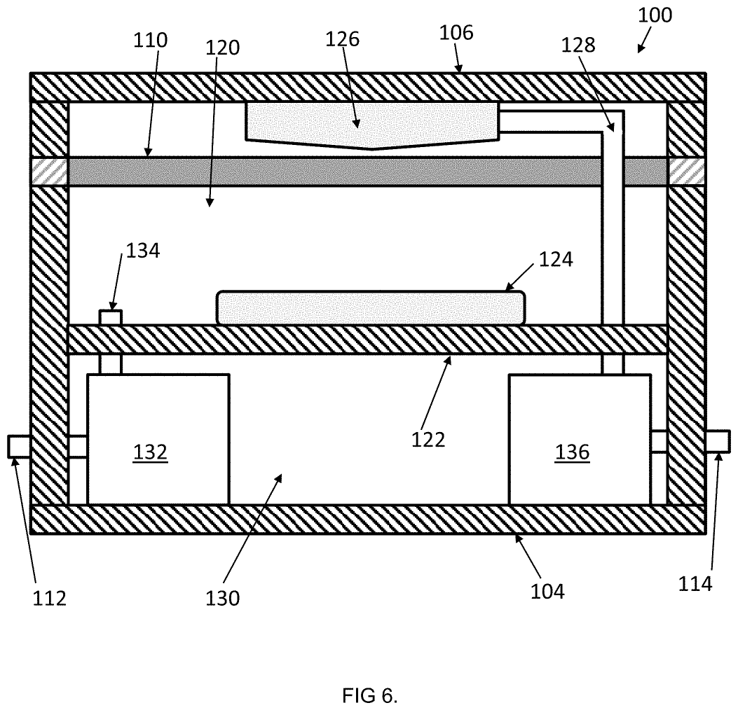

Referring now to FIG. 6, screen protector applicator 100 includes an upper chamber 120 and a lower chamber 130. Upper chamber 120 is the area where the screen protector application process occurs, and includes an alignment fixture 124 and airbag 126. Both upper chamber 120 and lower chamber 130 are isolated from one another via divider 122. Lower chamber 130 houses pumps 132 and 136, as well as various electrical components, such as a control unit, that operate pumps 132 and 136. Pumps 132 and 136 can also have internal valves to prevent back flow of fluid pressure during the screen application process, or separate valves could be used. Pump 132 is in fluid communication with upper chamber 120 via tube 134 and with the atmosphere via tube 112. Pump 136 is in fluid communication with airbag 126 via tube 128 and with atmosphere via tube 114. Pumps 132 and 136 are electro-pneumatic pumps, but any other suitable pump type can be used.

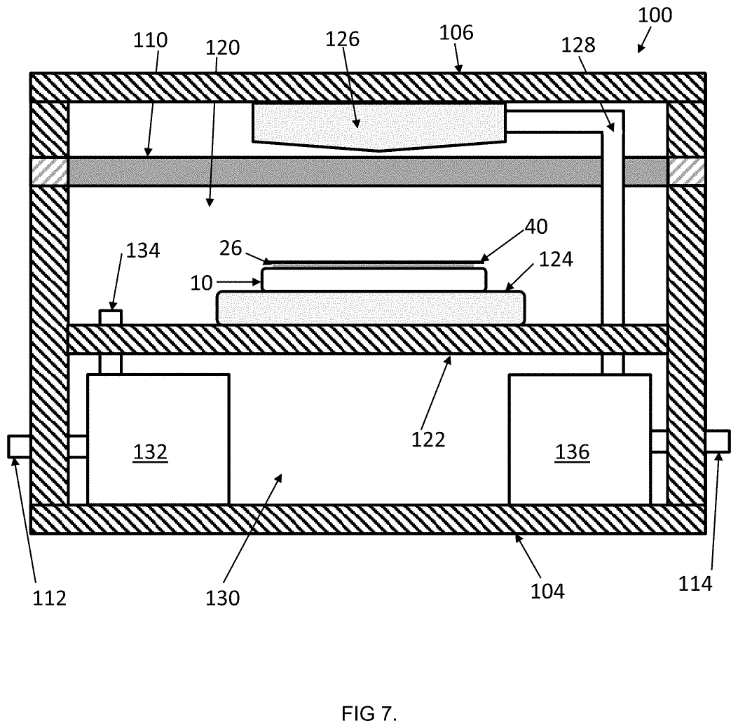

Referring now to FIG. 7, electronic device 10 is placed on alignment fixture 124 within screen protector applicator 100. In some embodiments, an adhesive layer 26 is applied separately from a screen protector. Protective film 40 is arranged on top of adhesive layer 26 to prevent adhesive layer 26 from sticking to airbag 126 during the process. Once screen protector applicator 100 is sealed, pump 132 activates to evacuate upper chamber 120 of any air within upper chamber 120. Simultaneously, pump 136 activates to evacuate airbag 126 of any air with the air bag, and to keep static balance within upper chamber 120, otherwise airbag 126 could expand due to the vacuum created by pump 132 in upper chamber 120. If airbag 126 were to contact adhesive layer 26 prior to reaching a desired vacuum pressure, bubbles could form between screen 12 and adhesive layer 26.

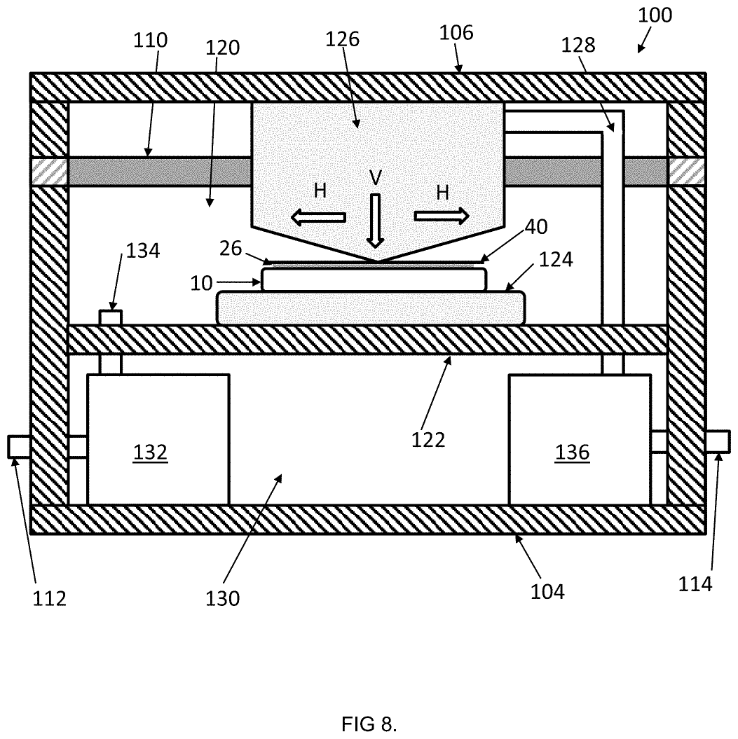

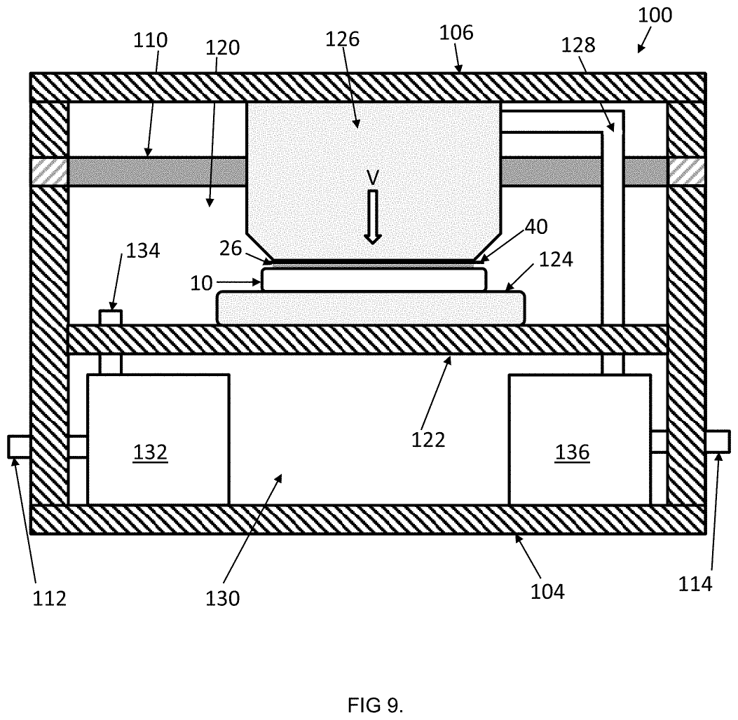

Referring now to FIG. 8 and FIG. 9, once a desired vacuum pressure is reached within upper chamber 120, pump 132 can either switch off and seal upper chamber 120 via a valve, or continue creating a vacuum with upper chamber 120. Pump 136 can either vent airbag 126 to atmospheric pressure via tube 114, or can reverse direction and create a positive pressure within airbag 126. This venting to atmospheric pressure or positive pressure will slowly distend the airbag downward into the upper chamber 120 in order to make contact with protective film 40. The initial point of contact for airbag 126 would ideally be at the center of protective film 40. However, in some embodiments, airbag 126 can contact protective film 40 at an edge and slowly inflate across protective film 40 towards the opposing edge. Once airbag 126 makes contact with protective film 40, a vertical force V and horizontal force H will be applied to the adhesive layer. By having initial contact in the center of protective film 40, air bubbles contained within adhesive layer 26 will be forced towards the perimeter of adhesive layer 26, and then out of adhesive layer 26. Additionally, the vacuum created within upper chamber 120 will aid in pulling any air bubbles out of adhesive layer 26. Over time, as airbag 126 slowly fills with positive pressure, airbag 126 will expand towards the perimeter of adhesive layer 26, forcing all trapped air bubbles out of adhesive layer 26 through the perimeter. Vertical force V will also form adhesive layer 26 to the surface geometry of screen 12 of electronic device 10. After airbag 126 has fully inflated and mated adhesive layer 26 to screen 12, pump 123 and pump 136 are deactivated. Airbag 126 is vented to atmospheric pressure in order to deflate, and upper chamber 120 is vented to atmospheric pressure to remove the vacuum created by pump 132.

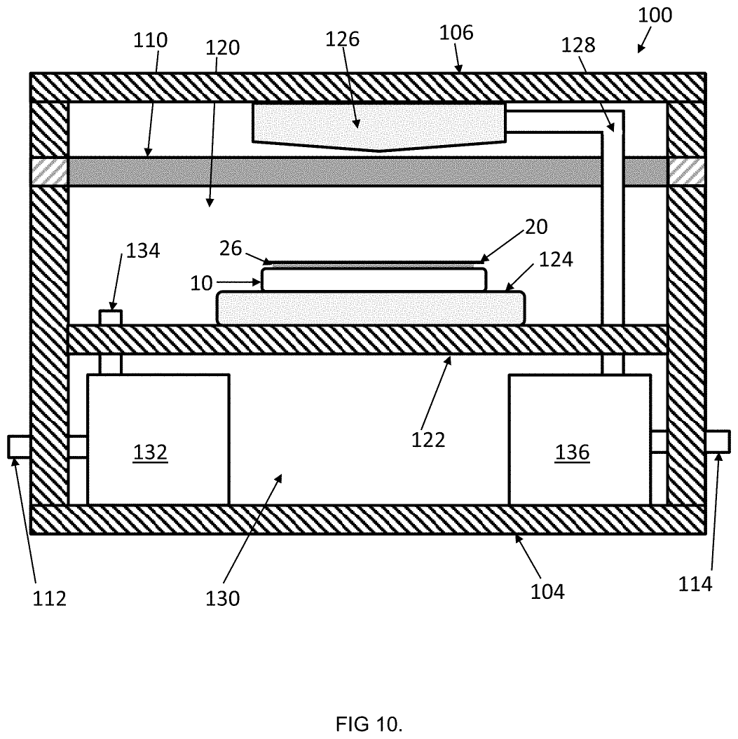

Referring now to FIG. 10, electronic device 10 remains on alignment fixture 124 within screen protector applicator 100 after adhesive layer 26 is applied to screen 12. In some embodiments, screen protector 20 and adhesive layer 26 are applied simultaneously in one process. Protective film 40 is removed from adhesive layer 26 and screen protector 20 is arranged on adhesive layer 26 and electronic device 10. Once screen protector applicator 100 is sealed, pump 132 activates to evacuate upper chamber 120 of any air within upper chamber 120. Simultaneously, pump 136 activates to evacuate airbag 126 of any air with the air bag, and to keep static balance within upper chamber 120, otherwise airbag 126 could expand due to the vacuum created by pump 132 in upper chamber 120. If airbag 126 were to contact adhesive layer 26 prior to reaching a desired vacuum pressure, bubbles could form between screen 12 and adhesive layer 26.

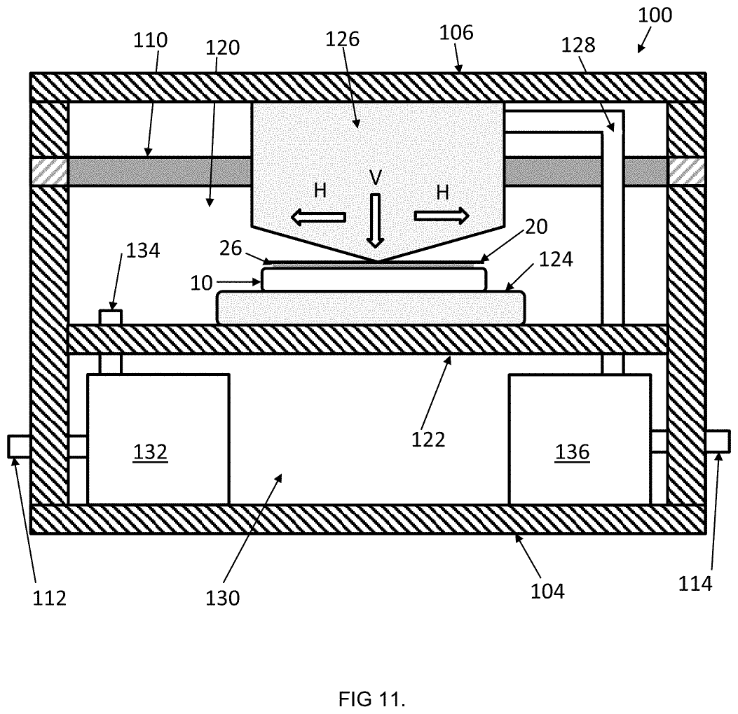

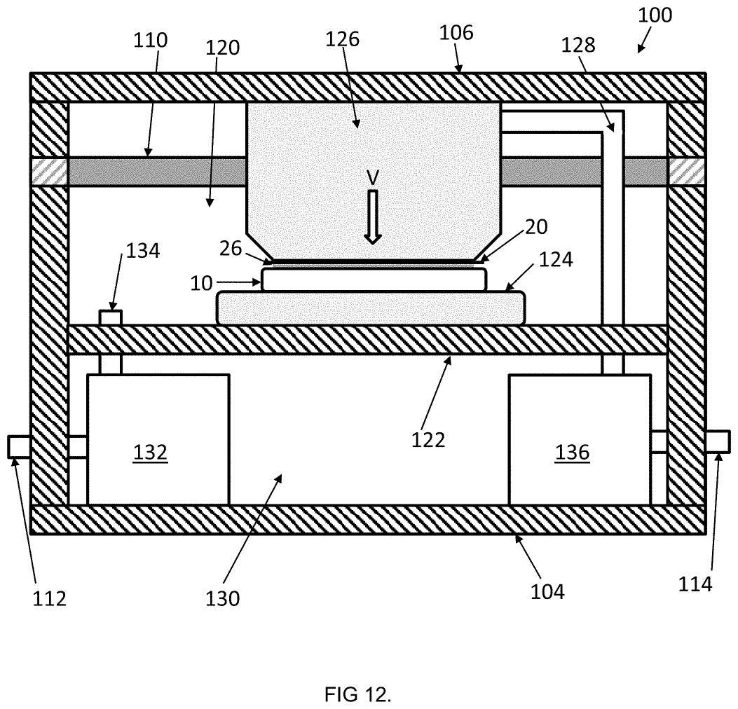

Referring now to FIG. 11 and FIG. 12, once a desired vacuum pressure is reached within upper chamber 120, pump 132 can either switch off and seal upper chamber 120 via a valve, or continue creating a vacuum with upper chamber 120. Pump 136 can either vent airbag 126 to atmospheric pressure via tube 114, or can reverse direction and create a positive pressure within airbag 126. This venting to atmospheric pressure or positive pressure will slowly distend the airbag downward into the upper chamber 120 in order to make contact with top surface 22 of screen protector 20. The initial point of contact for airbag 126 would ideally be at the center of screen protector 20. However, in some embodiments, airbag 126 can contact screen protector 20 at an edge and slowly inflate across screen protector 20 towards the opposing edge. Once airbag 126 makes contact with screen protector 20, a vertical force V and horizontal force H will be applied to the adhesive layer 26 and screen protector 20. By having initial contact in the center of screen protector 20, air bubbles contained between mating surface 24 and adhesive layer 26 will be forced towards the perimeter of screen protector 20, and then out of from under screen protector 20. Additionally, the vacuum created within upper chamber 120 will aid in pulling any air bubbles out from between screen protector 20 and adhesive layer 26. Over time, as airbag 126 slowly fills with positive pressure, airbag 126 will expand towards the perimeter of screen protector 20, forcing all trapped air bubbles out from between screen protector 20 and adhesive layer 26 through the perimeter. Vertical force V will also form screen protector 20 to the surface geometry of screen 12 of electronic device 10. After airbag 126 has fully inflated and mated screen protector 20 to screen 12, pump 123 and pump 136 are deactivated. Airbag 126 is vented to atmospheric pressure in order to deflate, and upper chamber 120 is vented to atmospheric pressure to remove the vacuum created by pump 132.

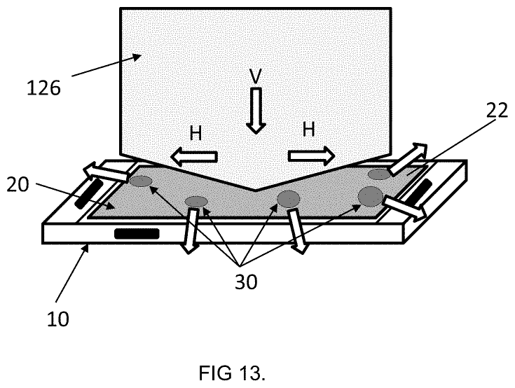

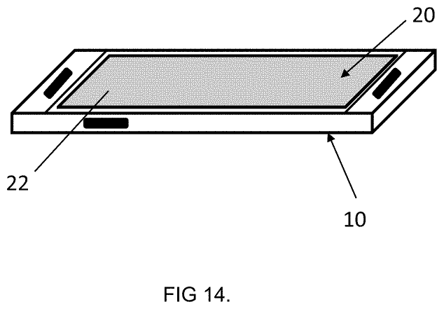

Referring now to FIG. 13 and FIG. 14, as airbag 126 impacts screen protector 20 during the preform process, the air bubbles trapped between screen protector 20 and screen 12 will be forced outward towards the perimeter of screen protector 20. In some embodiments, the air bubbles will travel in a linear path radiating outward from the point of contact by air bag 126 to the perimeter of screen protector 20. The end result of the process will be a screen protector 20 mated to screen 12 without any preventable bubbles formed between the two surfaces.

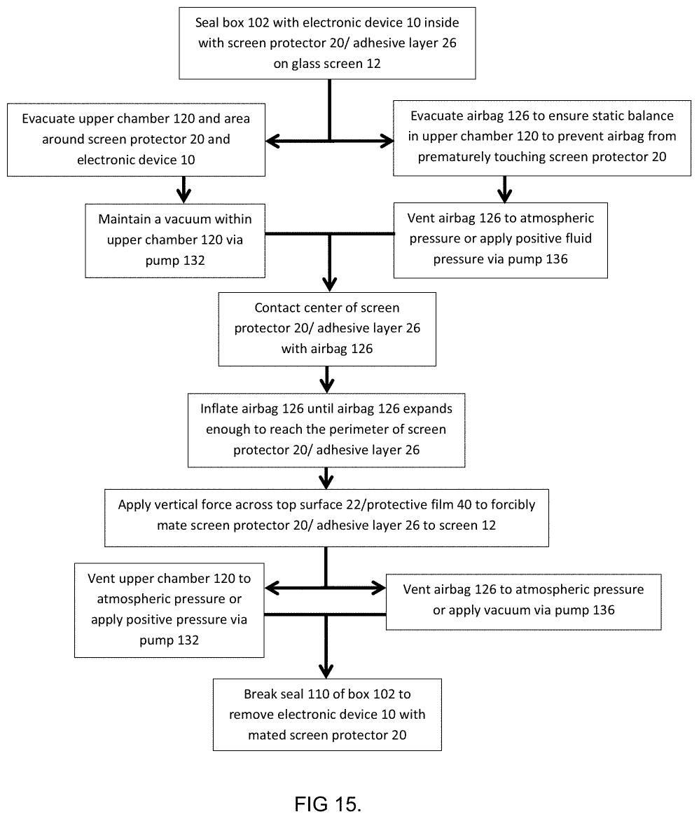

FIG. 15 represents a flow chart of an embodiment of above mentioned process of applying a screen protector to a glass cover screen.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of applying a screen protector to a surface, comprising:
aligning a first mating surface with a second mating surface within a chamber;
creating a vacuum within the chamber;
inflating an airbag arranged within the chamber;
contacting the first mating surface with the airbag;
inflating the airbag to extend towards the perimeter of the first mating surface and second mating surface; and
removing fluid trapped between the first mating surface and the second mating surface.

2. The method of claim 1, wherein the first mating surface further includes an adhesive layer arranged between the first mating surface and second mating surface.

3. The method of claim 1, further comprising forcibly mating the first mating surface to the second mating surface.

4. The method of claim 1, wherein the fluid trapped between the first mating surface and the second mating surface is air.

5. The method of claim 1, wherein the airbag initially contacts the center of the first mating surface.

6. The method of claim 1, wherein the first mating surface and the second mating surface are glass.

7. The method of claim 2, wherein the adhesive layer is applied to the second mating surface prior to the first mating surface.

8. The method of claim 1, wherein the airbag is inflated via a pump.

9. The method of claim 1, wherein the airbag is inflated via atmospheric pressure.

10. The method of claim 1, wherein the airbag is arranged above the first mating surface and second mating surface.

11. The method of claim 1, wherein the first mating surface and second mating surface are held in place by an alignment fixture when contacted by the airbag.

12. A screen protector application system, comprising:
a chamber that can hold a vacuum;
an extendable member arranged on the top surface of the chamber; and
a pump arranged to apply a vacuum to the chamber,
wherein when a vacuum is applied to the chamber via the pump, the extendable member extends downward into the chamber and contacts a first mating surface and a second mating surface, wherein the pressure from the extendable member forces any air arranged between the first mating surface and second mating surface out through the perimeter of the first mating surface.

13. The screen protector application system of claim 12, wherein the extendable member is an airbag.

14. The screen protector application system of claim 12, wherein an adhesive layer is arranged between the first mating surface and second mating surface.

15. The screen protector application system of claim 12, further comprising a valve fluidly coupled to the airbag.

16. The screen protector application system of claim 12, wherein the extendable member applies a horizontal and vertical force to the first mating surface and second mating surface.

17. The screen protector application system of claim 12, further comprising an alignment fixture to secure the first mating surface and second mating surface during contact with the extendable member.

18. The screen protector application system of claim 15, further comprising a control unit communicatively connected with the pump and valve, and comprising a processor, a memory, and a computer readable and executable instruction set.

19. The screen protector application system of claim 12, wherein the extendable member initially contacts the center of the first mating surface and moves outward towards the perimeter of the first mating surface.

20. A method of applying a screen protector to a surface, comprising:
sealing a chamber with electronic device arranged inside having a screen protector and/or adhesive layer arranged on a glass screen of the electronic device;
evacuating the chamber;
evacuating an airbag arranged within the chamber;
maintaining a vacuum within the chamber;
venting the airbag to atmospheric pressure or applying positive fluid pressure;
contacting a center point of the screen protector and/or adhesive layer with the airbag;
inflating the airbag until the airbag expands enough to reach the perimeter of the screen protector and/or adhesive layer;
applying a vertical force across a top surface of the screen protector and/or adhesive layer to forcibly mate the screen protector and/or adhesive layer to the screen;
venting the upper chamber to atmospheric pressure or applying positive pressure;
venting the airbag to atmospheric pressure or applying vacuum; and
breaking the seal to remove the electronic device.

21. A screen protector application system as described herein.

22. A screen protector application method as described herein.
